(19) United States
(12) Patent Application Publication
(10) Pub. No.: US 2025/0050302 A1
(43) Pub. Date: Feb. 13, 2025

(54) FURNACE AND MANUFACTURING APPARATUS FOR GLASS PARTICLE DEPOSIT INCLUDING THE SAME

(71) Applicant: SUMITOMO ELECTRIC INDUSTRIES, LTD., Osaka-shi, Osaka (JP)

(72) Inventor: Tomomi MORIYA, Osaka-shi, Osaka (JP)

(21) Appl. No.: 18/721,982

(22) PCT Filed: Dec. 21, 2022
(86) PCT No.: PCT/JP2022/047190

§ 371 Date: Jun. 20, 2024

(30) Foreign Application Priority Data
Dec. 22, 2021 (JP) 2021-208161

(51) Int. Cl. B01J 19/24; B01J 19/00; C01B 33/18; C03B 37/018

(52) U.S. Cl. CPC B01J 19/24; B01J 19/0013; C01B 33/183; C03B 37/01815; B01J 2219/00157

(57) ABSTRACT

The present disclosure relates to a furnace for manufacturing a glass particle deposit by depositing glass particles generated from a glass raw material. The furnace includes two or more portions that are not fixed to each other in an upper-lower direction which is an axial direction of the glass particle deposit. The two or more portions include a first portion and a second portion which are independently formed, and the two or more portions have a structure in which the first portion and the second portion do not interfere with each other when the first portion is deformed by thermal expansion.

### TECHNICAL FIELD

The present disclosure relates to a furnace and a manufacturing apparatus for a glass particle deposit including the same. The present application is based on and claims priority to Japanese Application No. 2021-208161 filed on Dec. 22, 2021, the entire contents of which are incorporated herein by reference.

### BACKGROUND ART

Patent Literature 1 describes a manufacturing method of a glass particle deposit for depositing glass particles on a starting material.

### CITATION LIST

### Patent Literature

Patent Literature 1: JP2004-099353A

### SUMMARY OF INVENTION

A furnace according to an aspect of the present disclosure is a furnace for manufacturing a glass particle deposit by depositing glass particles generated from a glass raw material, the furnace including: two or more portions that are not fixed to each other in an upper-lower direction which is an axial direction of the glass particle deposit, in which the two or more portions include a first portion and a second portion which are independently formed, and the two or more portions have a structure in which the first portion and the second portion do not interfere with each other when the first portion is deformed by thermal expansion.

A manufacturing apparatus for a glass particle deposit according to an aspect of the present disclosure includes: the furnace described in the preceding paragraph.

### BRIEF DESCRIPTION OF DRAWINGS

FIG. 1 is a diagram schematically showing a manufacturing apparatus for a glass particle deposit according to an embodiment of the present disclosure.

FIG. 2 is a perspective view schematically showing a furnace illustrated in FIG. 1.

FIG. 3 is a schematic view showing a positional relationship among a furnace middle portion, an exhaust pipe, and an outer container.

FIG. 4 is a schematic diagram for illustrating thermal expansion in the furnace.

### DESCRIPTION OF EMBODIMENTS

### Problem to be Solved by Present Disclosure

In a step of generating glass particles from a glass raw material and depositing the glass particles, a temperature in the furnace increases due to radiant heat or the like emitted from the glass particle deposit. As a result, the furnace may thermally expand and break. However, Patent Literature 1 is silent about breakage caused by thermal expansion of the furnace, and does not disclose any measure against the damage.

An object of the present disclosure is to suppress breakage of a furnace due to thermal expansion.

### Advantageous Effects of Present Disclosure

According to the present disclosure, breakage of the furnace due to thermal expansion can be suppressed.

### Description of Embodiment of Present Disclosure

First, an embodiment of the present disclosure will be listed and described.

(1) A furnace according to an aspect of the present disclosure is a furnace for manufacturing a glass particle deposit by depositing glass particles generated from a glass raw material, the furnace including: two or more portions that are not fixed to each other in an upper-lower direction which is an axial direction of the glass particle deposit, in which the two or more portions include a first portion and a second portion which are independently formed, and the two or more portions have a structure in which the first portion and the second portion do not interfere with each other when the first portion is deformed by thermal expansion.

According to this configuration, even if the furnace thermally expands due to radiant heat or the like emitted from the glass particle deposit or the like, it is possible to suppress breakage of the furnace due to the thermal expansion.

(2) The furnace according to the above (1), in which: the two or more portions preferably include a furnace upper portion, a furnace middle portion located below the furnace upper portion, and a furnace lower portion located below the furnace middle portion; the furnace middle portion is preferably the first portion and has an upper end opening and a lower end opening in the upper-lower direction; the furnace upper portion is preferably the second portion and covers the upper end opening of the furnace middle portion so as to have a gap with an upper end of the furnace middle portion in the upper-lower direction; and the furnace lower portion preferably covers the lower end opening of the furnace middle portion and supports the furnace middle portion.

According to this configuration, since the furnace middle portion is not fixed to the furnace upper portion or the furnace lower portion and is supported by the furnace lower portion in a movable state, the furnace middle portion does not interfere with the furnace upper portion when the furnace middle portion thermally expands. For example, even if the furnace middle portion thermally expands in the upper-lower direction due to the radiant heat or the like emitted from the glass particle deposit or the like, deformation due to the thermal expansion can be allowed by a gap between the furnace upper portion and the upper end of the furnace middle portion. As a result, the breakage of the furnace due to the thermal expansion can be suppressed.

(3) The furnace according to the above (2), in which the gap is preferably 3 mm or more.

According to this configuration, since the gap equal to or larger than a displacement amount estimated to occur due to the thermal expansion is provided between the furnace upper portion and the upper end of the furnace middle portion, it is possible to further suppress the breakage of the furnace due to the thermal expansion.

(4) The furnace according to the above (2) or (3), in which a distance between portions of the furnace upper portion and the furnace middle portion facing each other in a left-right direction perpendicular to the upper-lower direction is 1 mm or less.

According to this configuration, sealability of the entire furnace can be enhanced. As a result, for example, when the glass raw material is silicon tetrachloride, corrosive gas or the like such as chlorine generated as a by-product of the glass particle can be prevented from leaking to an outside of the furnace.

(5) The furnace according to any one of the above (1) to (4), in which the glass raw material is silicon tetrachloride.

When the glass particles are generated from the silicon tetrachloride generally used for an optical fiber, silicon tetrachloride is subjected to an oxidation reaction in a flame injected from a burner, so that a temperature in the furnace increases. The furnace of the present disclosure is hardly broken by the thermal expansion even when the temperature of the furnace increases, and thus can also be applied to a case where the silicon tetrachloride is used as the glass raw material.

(6) A manufacturing apparatus for a glass particle deposit according to an aspect of the present disclosure includes: the furnace according to any one of the above (1) to (5).

According to this configuration, in the manufacturing apparatus for a glass particle deposit, even if the furnace is thermally expanded due to radiant heat or the like emitted from the glass particle deposit or the like, breakage of the furnace due to the thermal expansion can be suppressed.

### Details of Embodiment of Present Disclosure

Hereinafter, an example of an embodiment of a furnace and a manufacturing apparatus for a glass particle deposit including the same according to the present disclosure will be described with reference to the drawings. The dimensions of members shown in the drawings are for convenience of description and may be different from actual dimensions of the members. In addition, the same or equivalent components or members shown in the respective drawings are denoted by the same reference numerals, and redundant description thereof will be appropriately omitted.

### (Manufacturing Apparatus for Glass Particle Deposit)

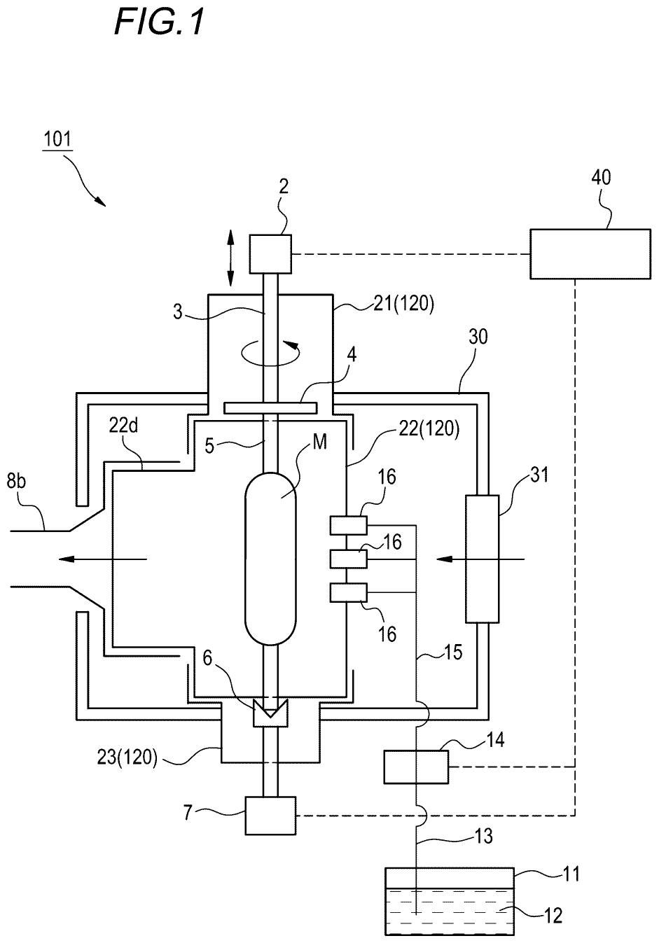

First, a manufacturing apparatus 101 for a glass particle deposit M according to an embodiment of the present disclosure will be described with reference to FIG. 1. FIG. 1 is a diagram schematically showing the manufacturing apparatus 101 for the glass particle deposit M according to the present embodiment. The manufacturing apparatus 101 includes an elevating rotation device 2, a support device 7, a raw material container 11, a vaporizing unit 14, burners 16, a furnace 120, an outer container 30, and a control unit 40.

The furnace 120 is a container in which the glass particle deposit M is formed. The furnace 120 includes three portions that are not fixed to each other in an upper-lower direction which is an axial direction of the glass particle deposit M. That is, the furnace 120 has a structure divided into a furnace upper portion 21, a furnace middle portion 22 located below the furnace upper portion 21, and a furnace lower portion 23 located below the furnace middle portion 22. In this case, the furnace upper portion 21 corresponds to a second portion, and the furnace middle portion 22 corresponds to a first portion.

The furnace upper portion 21 and the furnace lower portion 23 can be fixed to, for example, the outer container 30. The furnace middle portion 22 is supported by the furnace lower portion 23, for example, by being placed on the furnace lower portion 23, but is not fixed to the furnace upper portion 21 or the furnace lower portion 23. That is, the furnace middle portion 22 is movable between the furnace upper portion 21 and the furnace lower portion 23.

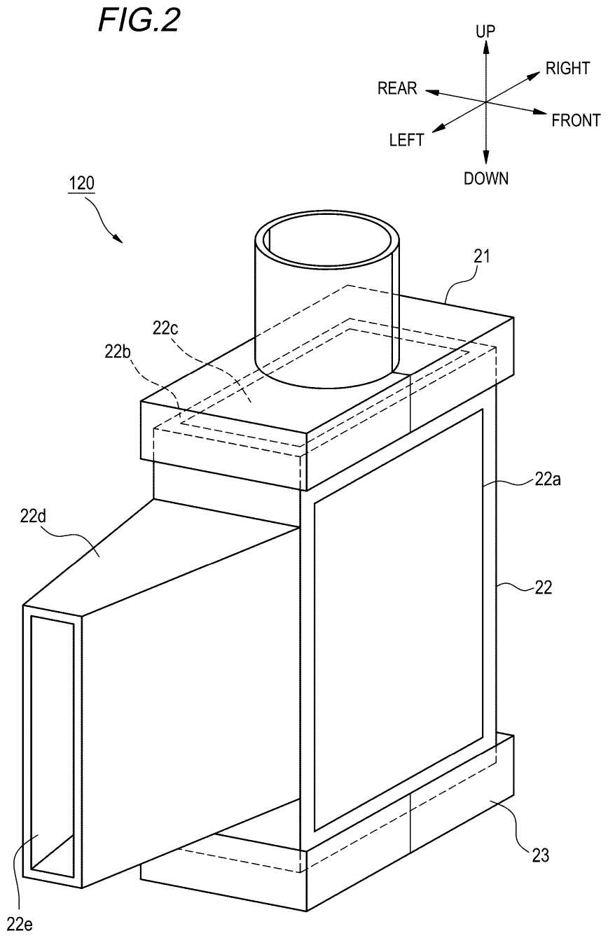

A burner hole (not shown) into which the burners 16 are inserted is provided in a side surface of the furnace middle portion 22. The furnace middle portion 22 has an exhaust unit 22d extending in a direction facing the burners 16 with the glass particle deposit M interposed therebetween. The exhaust unit 22d is provided with an exhaust opening 22e (see FIG. 2). One end of an exhaust pipe 8b is configured to cover the exhaust opening 22e. Excess soot or the like is discharged from the exhaust unit 22d in a direction indicated by an arrow together with gas in the furnace middle portion 22. Further, the exhaust unit 22d also performs heat dissipation in the furnace middle portion 22. From the viewpoint of increasing the efficiency of discharge of excess soot and the heat dissipation, a length of the exhaust unit 22d in the upper-lower direction is preferably equal to or longer than a distance between the uppermost burner 16 and the lowermost burner 16.

The elevating rotation device 2 is a device for elevating and rotating the glass particle deposit M via a support rod 3 and a starting rod 5. The elevating rotation device 2 controls an operation of the support rod 3 based on a control signal transmitted from the control unit 40. The elevating rotation device 2 elevates the glass particle deposit M while rotating the glass particle deposit M.

The support rod 3 is inserted through a through hole formed in an upper wall of the furnace upper portion 21. A partition plate 4 and the starting rod 5 are attached to one end portion (lower end portion in FIG. 1) of the support rods 3 disposed in the furnace 120. The partition plate 4 has, for example, the same size as a horizontal cross section of the upper wall of the furnace upper portion 21. The other end portion of the support rods 3 (the upper end in FIG. 1) is held by the elevating rotation device 2. The starting rod 5 is a rod on which glass particles are deposited. The exhaust pipe 8b is a pipe that discharges the glass particles (excess soot) or the like not attached to the starting rod 5 and the glass particle deposit M to the outside of the furnace 120 in the direction of the arrow in FIG. 1 together with the gas in the furnace 120.

The support device 7 is a device that supports the starting rod 5 via a contact portion 6 to suppress swirling. The contact portion 6 is in contact with the starting rod 5. The support device 7 controls the contact portion 6 to perform an elevating operation following the movement of the starting rod 5 based on the control signal transmitted from the control unit 40.

For example, a liquid glass raw material 12 is stored in the raw material container 11. As the glass raw material 12, for example, silicon tetrachloride can be used. When the glass raw material 12 is silicon tetrachloride, corrosive gas is generated as a by-product. Therefore, from the viewpoint of having corrosion resistance, for example, heat-resistant glass, nickel, or a nickel alloy is preferably used as a material of the furnace 120.

The glass raw material 12 is not limited to the above example, and for example, siloxane may be used. When siloxane is used as the glass raw material 12, no corrosive gas is generated. Therefore, it is not necessary to consider the corrosion resistance as the material of the furnace 120, and for example, inexpensive stainless steel, iron, aluminum, or the like may be used.

The glass raw material 12 in the raw material container 11 is supplied to the vaporizing unit 14 through a supply pipe 13. The vaporizing unit 14 vaporizes the glass raw material 12 into a glass raw material gas based on the control signal transmitted from the control unit 40. When the glass raw material is silicon tetrachloride, a bub ring may be used as the vaporizing unit. The glass raw material gas is supplied to the burners 16 through a temperature control pipe 15. A temperature in the temperature control pipe 15 is maintained at a high temperature such that the glass raw material gas is not liquefied. The temperature control pipe 15 is, for example, a pipe wound around by a tape heater which is a heating element.

The number of burners 16 is not particularly limited, and may be one or two or more. In the example of FIG. 1, the number of burners 16 is three. The burner 16 is supplied with the glass raw material gas vaporized in the vaporizing unit 14 and a gas for flame formation. Examples of the gas for flame formation include a hydrogen gas and an oxygen gas. Further, an inert gas such as a nitrogen gas or an argon gas may also be supplied to the burners 16 as a seal gas. In FIG. 1, a supply device for supplying the gas for flame formation to the burners 16 and a supply device for supplying the seal gas to the burners 16 are not shown. For example, the burner 16 generates glass particles by causing an oxidation reaction of the glass raw material gas in a flame, and sprays the generated glass particles onto the starting rod 5 to deposit the glass particles.

The outer container 30 is a container that covers a periphery of the furnace 120. The outer container 30 is provided with a clean air supply device 31. The clean air supply device 31 supplies clean air into the outer container 30 as indicated by an arrow in FIG. 1. In the example of FIG. 1, a portion excluding an upper portion of the furnace upper portion 21 and a lower portion of the furnace lower portion 23 is covered with the outer container 30 filled with the clean air. When the glass raw material 12 is silicon tetrachloride, the outer container 30 is also preferably made of a metal having corrosion resistance. On the other hand, when the glass raw material 12 is siloxane, it is also not necessary to consider the corrosion resistance of the material of the outer container 30, and for example, inexpensive stainless steel, iron, aluminum, or the like may be used.

The control unit 40 controls each operation of the elevating rotation device 2. The control unit 40 transmits a control signal for controlling an elevating speed and the rotation speed of the glass particle deposit M with respect to the elevating rotation device 2. Further, the control unit 40 controls the amount of the glass raw material gas supplied to the burners 16 by controlling an operation of the vaporizing unit 14. The control unit 40 controls each operation of the support device 7.

Next, the furnace 120 will be described in more detail with reference to FIGS. 2 to 4.

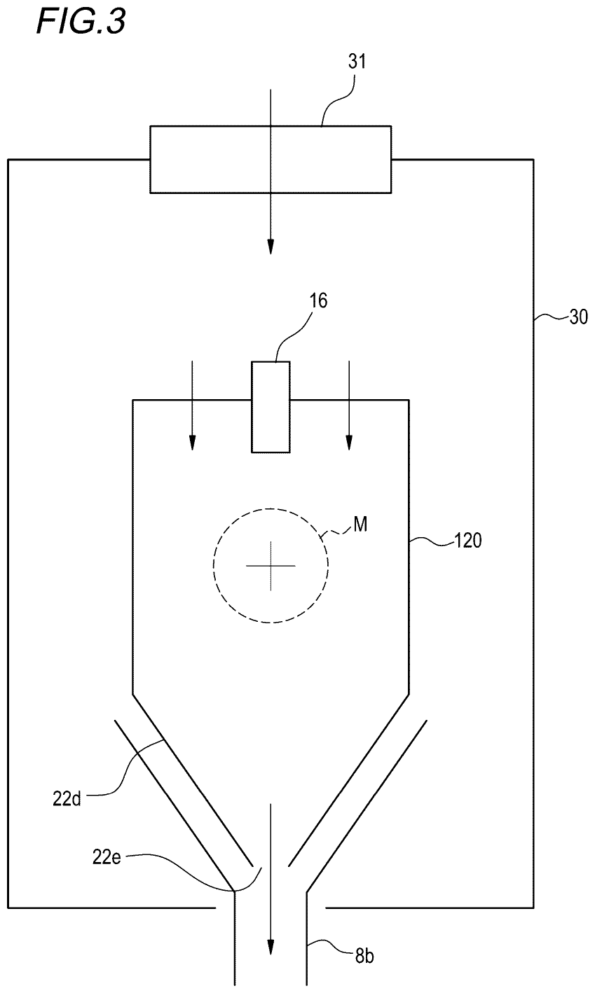

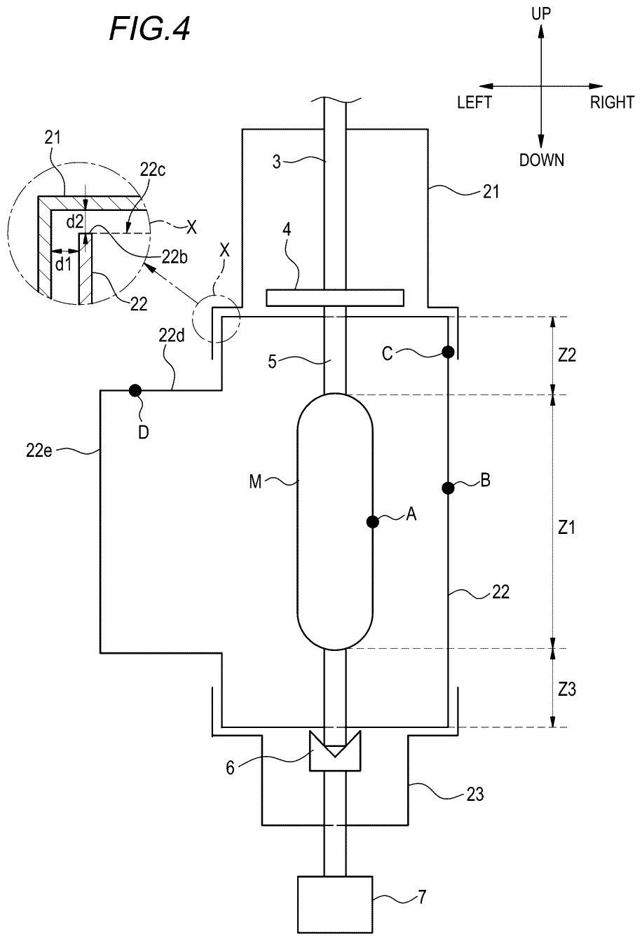

FIG. 2 is a perspective view schematically showing the furnace 120 shown in FIG. 1. The upper-lower direction shown in FIG. 2 is the axial direction of the glass particle deposit M when the glass particle deposit M is manufactured. A left-right direction shown in FIG. 2 is a direction orthogonal to the upper-lower direction, and is a direction in which the exhaust unit 22d and the burners 16 (not shown in FIG. 2) face each other. A front-rear direction shown in FIG. 2 is a direction orthogonal to the upper-lower direction and the left-right direction. These directions are set to facilitate understanding of the present disclosure, and do not limit the present disclosure. Directions shown in FIGS. 3 and 4 are also as described above.

As shown in FIG. 2, the furnace middle portion 22 has a door portion 22a that opens and closes in the front-rear direction. By opening the door portion 22a, work in the furnace middle portion 22 becomes possible. In order to facilitate attachment, the furnace upper portion 21 and the furnace lower portion 23 are configured to be openable and closable to the left and right. The exhaust unit 22d is provided to extend leftward. The exhaust opening 22e for exhausting air and dissipating heat is provided at a left end of the exhaust unit 22d.

An upper end opening 22c is provided at an upper end 22b of the furnace middle portion 22. The furnace upper portion 21 covers the upper end opening 22c so as to have a gap with the upper end 22b in the upper-lower direction. Although not shown, a lower end opening is provided at a lower end of the furnace middle portion 22. The furnace lower portion 23 covers the lower end opening. That is, the furnace middle portion 22 has a cylindrical shape having both ends opened in the upper-lower direction, and the furnace upper portion 21 and the furnace lower portion 23 serve as lids for closing openings at both of the ends.

FIG. 3 is a schematic view showing a positional relationship among the furnace middle portion 22, the exhaust pipe 8b, and the outer container 30. As shown in FIG. 3, the furnace middle portion 22 is located inside the outer container 30. The clean air is supplied from the clean air supply device 31 to the outer container 30 as indicated by an arrow. Thus, a space between the furnace middle portion 22 and the outer container 30 is filled with the clean air. Further, a clean-air supply hole (not shown) is provided in the furnace middle portion 22, and the clean air is also supplied to the furnace middle portion 22 as indicated by an arrow.

A distance of the exhaust unit 22d in the front-rear direction decreases leftward. The exhaust pipe 8b is provided to cover the exhaust unit 22d and the exhaust opening 22e, and prevents excess soot or the like from the furnace middle portion 22 from entering the space between the furnace middle portion 22 and the outer container 30.

FIG. 4 is a schematic diagram for illustrating thermal expansion in the furnace 120. During the manufacturing of the glass particle deposit M, radiant heat is emitted from the glass particle deposit M. Due to the radiant heat or the like, for example, a temperature at a point A may be 1200° C. or more, a temperature at a point B may be about 400° C., and temperatures at points C and D may be 200° C. or less. The point A is on a surface of the glass particle deposit M. The point B is a position in a region Z1 on a right side surface of the furnace middle portion 22. An upper end and a lower end of the region Z1 are located at positions corresponding to an upper end and a lower end of the glass particle deposit M at the end of the manufacturing. The point C is a position in a region Z2 on the right side surface of the furnace middle portion 22. The region Z2 is a region above the region Z1 on the right side surface of the furnace middle portion 22. The point D is a position near the exhaust opening 22e in the exhaust unit 22d.

When there is a temperature difference between the point B and the point C, the container at the point B thermally expands. When thermal expansion occurs at the point B, for example, the furnace middle portion 22 is deformed to extend upward. Here, when the furnace middle portion 22 is fixed to the furnace upper portion 21, the furnace upper portion 21 and the furnace middle portion 22 interfere with each other, which may lead to breakage. However, as shown in an upper left region X in FIG. 4 (an enlarged cross-sectional view when the furnace upper portion 21 and the furnace middle portion 22 are cleaved along a plane including the upper-lower direction and the left-right direction), a gap having a distance d2 in the upper-lower direction is provided between the furnace upper portion 21 and the upper end 22b of the furnace middle portion 22. As a result, even if the furnace middle portion 22 is deformed to extend upward, the furnace upper portion 21 and the furnace middle portion 22 do not interfere with each other. In other words, a force that breaks the furnace upper portion 21 and the furnace middle portion 22 is not generated. Although the distance d2 is not particularly limited, the distance d2 is preferably equal to or larger than a displacement amount in the upper-lower direction of the furnace middle portion 22 due to assumed thermal expansion. Specifically, the distance d2 is preferably 3 mm or more.

In an area Z3, the temperature is about 200° C. as in the area Z2. The region Z3 is a region below the region Z1 on the right side surface of the furnace middle portion 22. Thus, thermal expansion also occurs depending on a temperature difference between the region Z1 and the region Z3. In this case, when the thermal expansion occurs, for example, the furnace middle portion 22 is deformed to extend downward. Here, if the furnace middle portion 22 is fixed to the furnace lower portion 23, deformation due to the thermal expansion cannot be allowed, which may lead to breakage. However, since the furnace middle portion 22 is not fixed to the furnace lower portion 23, even if the furnace middle portion 22 is deformed to extend downward, the deformation is allowed. Even when the furnace middle portion 22 is deformed to extend downward, the displacement is allowed by the gap between the furnace upper portion 21 and the upper end 22b of the furnace middle portion 22.

As shown in the upper left region X of FIG. 4, a gap having a distance d1 in the left-right direction is provided between the furnace upper portion 21 and the furnace middle portion 22. Although the distance d1 is not particularly limited, the distance d1 is preferably equal to or greater than a displacement amount in the left-right direction of the furnace middle portion 22 due to the assumed thermal expansion. Specifically, the distance d1 is preferably about 1 mm. Note that, at the upper end of the furnace middle portion 22, displacement in the left-right direction due to the thermal expansion is considered to be small, and thus the distance d1 may be 1 mm or less, or may be 0 mm. By reducing the distance d1, sealability can be enhanced. The distance d1 can also be expressed as a distance between portions of the furnace upper portion 21 and the furnace middle portion 22 facing each other in the left-right direction.

Further, although not shown, it is preferable to provide a gap having a predetermined distance in the left-right direction between the furnace middle portion 22 and the furnace lower portion 23. Contents described for the distance d1 are incorporated in the predetermined distance.

At the point D, for example, the exhaust unit 22d is deformed to extend leftward due to a temperature difference from a region on a right side of the point D. Therefore, it is preferable to provide a gap between the left end of the exhaust unit 22d and the exhaust pipe 8b shown in FIG. 1, the gap having a distance equal to or larger than the displacement amount in the left-right direction of the exhaust unit 22d due to the assumed thermal expansion.

In the present embodiment, an example in which the furnace 120 is divided into the three portions has been described, but the present disclosure is not limited thereto. The furnace 120 may include two or more portions that are not fixed to each other in the upper-lower direction. The two or more portions may include a first portion and a second portion that are independently formed, and may have a structure in which the first portion and the second portion do not interfere with each other when the first portion is deformed by the thermal expansion. For example, a structure in which the furnace 120 is divided into the furnace upper portion 21 and a portion where the furnace middle portion 22 and the furnace lower portion 23 are integrated may be adopted. Further, a structure in which the furnace 120 is divided into a portion where the furnace upper portion 21 and the furnace middle portion 22 are integrated and the furnace lower portion 23 may be adopted.

The manufacturing apparatus 101 according to the present embodiment can be used without any particular limitation in a method for manufacturing the glass particle deposit in which the glass particles are generated from the glass raw material gas and deposited, and can be used in a manufacturing method known in the related art such as an outside vapor deposition (OVD) method, a vapor phase axial deposition (VAD) method, or a multiburner multilayer deposition (MMD) method.

Although the present embodiment has been described above, it goes without saying that the technical scope of the present invention should not be interpreted to be limited by the description of the embodiment. The present embodiment is merely an example, and it is understood by those skilled in the art that various modifications can be made to the present embodiment within the scope of the invention described in the claims. In this way, the technical scope of the present invention should be defined based on the scope of the invention described in the claims and the scope of equivalents thereof.

### REFERENCE SIGNS LIST

101: manufacturing apparatus (for glass particle deposit)
2: elevating rotation device
3: support rod
4: partition plate
5: starting rod
6: contact portion
7: support device
8b: exhaust pipe
11: raw material container
12: liquid siloxane
13: supply pipe
14: vaporizing unit
15: temperature control pipe
16: burner
120: furnace
21: furnace upper portion
22: furnace middle portion
22a: door portion
22b: upper end
22c: upper end opening
22d: exhaust unit
22e: exhaust opening
23: furnace lower portion
30: outer container
31: clean air supply device
40: control unit
d1 and d2: distance
M: glass particle deposit

What is claimed is:

1. A furnace for manufacturing a glass particle deposit by depositing glass particles generated from a glass raw material, the furnace comprising:
two or more portions that are not fixed to each other in an upper-lower direction which is an axial direction of the glass particle deposit,
wherein the two or more portions comprise a first portion and a second portion which are independently formed, and the the two or more portions have a structure in which the first portion and the second portion do not interfere with each other when the first portion is deformed by thermal expansion.

2. The furnace according to claim 1,
wherein the two or more portions comprise a furnace upper portion, a furnace middle portion located below the furnace upper portion, and a furnace lower portion located below the furnace middle portion,
wherein the furnace middle portion is the first portion and has an upper end opening and a lower end opening in the upper-lower direction,
wherein the furnace upper portion is the second portion and covers the upper end opening of the furnace middle portion so as to have a gap with an upper end of the furnace middle portion in the upper-lower direction, and
wherein the furnace lower portion covers the lower end opening of the furnace middle portion and supports the furnace middle portion.

3. The furnace according to claim 2,
wherein the gap is 3 mm or more.

4. The furnace according to claim 2,
wherein a distance between portions of the furnace upper portion and the furnace middle portion facing each other in a left-right direction perpendicular to the upper-lower direction is 1 mm or less.

5. The furnace according to claim 1,
wherein the glass raw material is silicon tetrachloride.

6. A manufacturing apparatus for a glass particle deposit, the manufacturing apparatus comprising:
the furnace according to claim 1.
